(19) United States
(12) Patent Application Publication
(10) Pub. No.: US 2024/0051128 A1
(43) Pub. Date: Feb. 15, 2024

(54) SKILL COMPOSITION AND SKILL TRAINING METHOD FOR THE DESIGN OF AUTONOMOUS SYSTEMS

(71) Applicant: MICROSOFT TECHNOLOGY LICENSING, LLC, Redmond, WA (US)

(72) Inventors: Kartavya NEEMA, Fremont, CA (US); Kazuhiro SASABUCHI, Redmond, WA (US); Aydan AKSOYLAR, San Mateo, CA (US); Naoki WAKE, Bellevue, WA (US); Jun TAKAMATSU, Redmond, WA (US); Ruofan KONG, Berkeley, CA (US); Marcos de MOURA CAMPOS, Encinitas, CA (US); Victor SHNAYDER, Berkeley, CA (US); Brice Hoani Valentin CHUNG, Oakland, CA (US); Katsushi IKEUCHI, Redmond, WA (US)

(21) Appl. No.: 18/061,965

(22) Filed: Dec. 5, 2022

Related U.S. Application Data
(60) Provisional application No. 63/371,308, filed on Aug. 12, 2022.

(51) Int. Cl. B25J 9/16

(52) U.S. Cl. CPC B25J 9/163; B25J 9/1669; B25J 9/1671

(57) ABSTRACT

The techniques disclosed herein enable a machine learning model to learn a termination condition of a sub-task. A sub-task is one of a number of sub-tasks that, when performed in sequence, accomplish a long-running task. A machine learning model used to perform the sub-task is augmented to also provide a termination signal. The termination signal indicates whether the sub-task's termination condition has been met. Monitoring the termination signal while performing the sub-task enables subsequent sub-tasks to seamlessly begin at the appropriate time. A termination condition may be learned from the same data used to train other model outputs. In some configurations, the model learns whether a sub-task is complete by periodically attempting subsequent sub-tasks. If a subsequent sub-task can be performed, positive reinforcement is provided for the termination condition. The termination condition may also be trained using synthetic scenarios designed to test when the termination condition has been met.

### CROSS-REFERENCE TO RELATED APPLICATIONS

The present application is a non-provisional application of, and claims priority to, U.S. Provisional Application Ser. No. 63/371,308 filed on Aug. 12, 2022, the contents of which are hereby incorporated by reference in their entirety.

### BACKGROUND

Machine learning has been effective at solving many different types of problems such as image classification, protein folding, translation of spoken language, etc. However, machine learning has been less successful at performing tasks with a long time horizon such as household robotics, autonomous driving, drone deliveries, etc. Often, a task with a long time horizon can be decomposed into a sequence of sub-tasks. For example, a robotic arm may perform a task of picking up a cup and placing it in on a shelf by performing sub-tasks such as grasping the cup, picking it up, bringing it to the shelf, placing it on the shelf, and releasing it.

One challenge faced when using machine learning to perform a task with a long time horizon is determining when one sub-task has been completed so that the next sub-task may begin. Continuing the example of moving the cup from the floor to the shelf, a traditional machine learning technique for solving this problem would begin by ascertaining the state of the environment—e.g., the location of the cup, the robotic arm, and the shelf. Given this initial state, the machine learning model would infer a series of hand positions and joint angles to grasp the cup. However, merely achieving the inferred positions and angles does not guarantee that the grasp sub-task has been completed and the “pick” sub-task may begin. The robotic arm may be touching the cup, but without enough force to prevent the cup from falling if the arm were to attempt to pick it up. As a result, the arm may have to use trial and error to determine if the grasp is strong enough. This makes the performance of the task inelegant, inefficient, and/or destructive.

In some cases, there is no mathematical formula to determine when a sub-task has completed. Continuing the example, even if the robotic arm is equipped with a sensor to detect whether the arm's fingers are in contact with the cup, no series of mathematical operations with or comparisons to this data is sufficient to determine whether the grasp is secure.

It is with respect to these and other considerations that the disclosure made herein is presented.

### SUMMARY

The techniques disclosed herein enable a machine learning model to learn a termination condition of a sub-task. A sub-task is one of a number of sub-tasks that, when performed in sequence, accomplish a long-running task. A machine learning model used to perform the sub-task is augmented to also provide a termination signal. The termination signal indicates whether the sub-task's termination condition has been met. Monitoring the termination signal while performing the sub-task enables subsequent sub-tasks to seamlessly begin at the appropriate time. A termination condition may be learned from the same data used to train other model outputs. In some configurations, the model learns whether a sub-task is complete by periodically attempting subsequent sub-tasks. If a subsequent sub-task can be performed, positive reinforcement is provided for the termination condition. The termination condition may also be trained using synthetic scenarios designed to test when the termination condition has been met.

In some configurations, the termination condition is trained using reinforcement learning, although any type of machine learning is similarly contemplated. In machine learning, a model is trained on a corpus of labeled inputs. From this corpus the model learns a function that maps individual inputs to individual outputs. For example, in computer vision, a classification model may be trained on millions of pictures labeled as containing a dog or a cat. During training, input images are provided to the model, and back-propagation is applied to adjust the weights of the model according to the labels of each image. Once trained, the classification model may be used to predict whether a given image contains a dog or a cat.

With reinforcement learning, the goal of the model is to maximize a reward. Instead of being trained with a label indicating the content of an image, the model is trained with a reward or a punishment depending on whether the model is making progress towards the goal. For the example of picking up a cup and placing it on a shelf, a reward function is defined for having placed the cup on the shelf. If a given input makes no progress towards the goal or regresses, the reward is negative, and via back-propagation the model is reinforced to steer away from that input. On the other hand, if the model has made progress towards achieving the goal, then positive reinforcement is provided, in effect encouraging the model towards the goal.

Reinforcement learning has been successful at accomplishing many kinds of tasks. For example, chess playing algorithms are often created with reinforcement learning. However, long horizon tasks are not easily solved with reinforcement learning. For the example of placing the cup on the shelf, providing negative feedback for failing to place the cup on the shelf is not specific enough to teach the joints to grasp the cup.

In order to better focus training scenarios, long horizon tasks can be decomposed into smaller sub-tasks. Each sub-task may have a defined goal that, once achieved, enables a subsequent sub-task to begin. Typically, the goals of the sub-tasks are more easily achieved than the overarching goal of the long horizon task. Long horizon tasks are often decomposed into sub-tasks that are reusable across multiple different long horizon tasks.

Each of the sub-tasks may be performed with a machine learning model that uses reinforcement learning or other machine learning technique. Continuing the example, the sub-task of grasping a cup may have a goal of moving the hand towards the cup and articulating the joints of the hand to hold the cup firmly enough that it can be lifted. Inputs of the model may be frames of a video that includes the arm, the cup, and the shelf. Model outputs may include arm position, joint angle, or other signal capable of controlling the robotic arm. While training the model, if model inputs result in model outputs that move the arm closer to the cup, a reward is provided. Similarly, if model outputs set joint angles that cause the arm to touch the cup, a reward is provided. If, for either goal, there is no progress towards the goal, or a regression, a negative reward is provided. Rewards may be encoded as a value between −1 and 1, although any range of values is similarly contemplated.

A “skill” refers to a set of actions that completes a sub-task. A skill uses the trained model to perform a sub-task. Skills may be composed together—e.g., performed in a sequence—to collectively perform a long-running task. A skill may use the termination signal of the machine learning model to determine when the skill is complete and the next skill can begin. A skill is re-usable, enabling the same sub-task to be performed for different long-running tasks. In order to be reusable to perform the same sub-task for different long-running tasks, the machine learning model may be trained against multiple subsequent sub-tasks.

In some configurations, the termination condition of the machine learning model is trained by performing a sub task until the termination signal is true, and then attempting to perform a subsequent sub-task. If the subsequent sub-task is able to begin, then positive reinforcement is provided for the termination condition. Specifically, positive reinforcement is provided for the inputs of the sub-task that caused the termination signal to be true. The positive reinforcement teaches the model which inputs are correctly associated with the termination condition being true. Since the skill may be used for different long-running tasks, various subsequent sub-tasks may be attempted, ensuring that the sub-task termination signal is robust for different applications.

In the example of a robotic arm grasping, picking up, bringing, placing, and releasing a cup, the model that performs the grasping sub-task may learn whether the grasp is complete by attempting the grasp and then, in response to the termination condition evaluating to true, attempting to perform the “pick” sub-task. For example, the arm may be moved as if to perform the “pick” sub-task, and a determination may be made whether the cup remained in the grasp throughout the arm's motion. If the cup did remain grasped by the arm, positive reinforcement may be applied to the termination condition, while if the cup did not remain grasped a negative reinforcement may be applied to the termination condition.

However, scenarios used to train a termination signal are not limited to attempting the next sub-task of a long-running task. For example, the arm could be made to perform a motion similar to the subsequent sub-task, an augmented version of the subsequent sub-task, or any other action derived from the subsequent sub-task. Continuing the example, the termination condition of the grasp sub-task may also be trained by attempting the grasp and then moving the arm in a motion similar to but different than the pick sub-task, such as moving the arm in different directions, at different speeds, and to different locations.

In some configurations, the termination condition may be trained by attempting to perform synthetic actions that are not related to any subsequent sub-task, but which may still inform whether the sub-task is successful. For each of these scenarios, if the cup remains in the arm's grasp, then positive reinforcement is provided for the termination condition. If the cup falls out of the arm's grasp, then negative reinforcement is provided.

Training the termination condition of the sub-task with different subsequent sub-tasks and with synthetic actions creates a termination condition that is robust and independent of the sub-task that happens to follow it. This generalizes the sub-task, allowing it to be applied to other long-running tasks.

In some instances, it is possible to mathematically determine whether a sub-task has been completed. For example, if a task requires moving an object to a specific location, a simple mathematical comparison between the actual position and the desired position can determine if the sub-task is complete. However, often there is no concise mathematical algorithm to determine if a sub-task is complete. In these scenarios, the termination condition is trained by attempting subsequent sub-tasks or related actions, as described herein.

In some configurations, the machine learning model that implements a sub-task is trained with data obtained from a simulation. The simulation may be used to generate sub-task completion training data by simulating actions that test whether the sub-task is complete. For example, in response to the termination signal for a sub-task being true, the simulator may simulate performing the subsequent sub-task to determine whether the sub-task was in fact complete. The simulation may also generate sub-task completion training data by simulating actions that are similar to, precursors of, or otherwise related to the subsequent sub-task. The simulation may apply these techniques for a number of potential subsequent sub-tasks, making the termination signal independent of any particular next sub-task. The simulation may also generate sub-task completion training data by simulating synthetic actions explicitly designed to test whether the sub-task is complete, but which are not related to any particular subsequent sub-task.

Continuing the example, sub-task completion training data may be generated for the grasp sub-task by simulating the grasp followed by simulating attempts to perform the pick sub-task. The termination condition is then trained according to whether the pick sub-task was successful. If the object starts to slip while the pick sub-task is performed, negative reinforcement is provided to the termination condition of the grasp sub-task. If the cup does not slip while being picked up, then positive reinforcement is provided.

Simulation environments may be used to generate training data by conducting these experiments repeatedly, and with different criteria. For example, a grasp may be attempted in simulation with coefficients of friction that are chosen at random, e.g. 10-20 different coefficients of friction. The grasp may also be attempted in simulation for objects that are deformable to different degrees, including not deformable at all. Success or failure of these different scenarios can be used to train the termination condition. Once the model is trained, the termination signal may be used in the real world when performing the long-horizon task.

While this document primarily discusses the scenario of using a robotic arm to pick up an object, the same technique for determining when one sub-task is complete and another begins applies equally to any type of sub-task or combination of sub-tasks. For example, the task may be to manufacture a product, which may be broken down into creating a mold, polishing the mold, installing a part in the mold, etc.

While this document primarily discusses videos or simulation-generated videos as model inputs, any type of input is similarly contemplated. For example, inputs can be audio signals, position sensor data, force sensor data, etc. Similarly, while this document primarily discusses model outputs that control a robotic arm, any other type of output is similarly contemplated, such as controlling when a molding machine is turned on and turned off, adjusting the focus depth of a camera, generating sound, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example of training a long horizon task to be performed by a robotic arm.

FIG. 1B illustrates breaking the long horizon task into sub-tasks.

FIG. 1C illustrates beginning to train a termination condition of a grasp sub-task.

FIG. 1D illustrates moving the robotic arm to touch a target object, triggering a termination signal.

FIG. 1E illustrates training the termination condition of the graph sub-task by attempting and failing to perform a pick sub-task.

FIG. 1F illustrates training the termination condition of the graph sub-task by attempting and succeeding to perform a pick sub-task.

FIGS. 2A-2C illustrate applying a trained machine learning model to perform a grasp sub-task, using a termination signal to determine when the sub-task is complete.

FIG. 3 is a flow diagram of an example method for training a machine learning model to perform a sub-task and to indicate when the sub-task is complete.

FIG. 4 is a computer architecture diagram illustrating an illustrative computer hardware and software architecture for a computing system capable of implementing aspects of the techniques and technologies presented herein.

FIG. 5 is a diagram illustrating a distributed computing environment capable of implementing aspects of the techniques and technologies presented herein.

### DETAILED DESCRIPTION

The techniques disclosed herein enable a machine learning model to learn a termination condition of a sub-task. A sub-task is one of a number of sub-tasks that, when performed in sequence, accomplish a long-running task. A machine learning model used to perform the sub-task is augmented to also provide a termination signal. The termination signal indicates whether the sub-task's termination condition has been met. Monitoring the termination signal while performing the sub-task enables subsequent sub-tasks to seamlessly begin at the appropriate time. A termination condition may be learned from the same data used to train other model outputs. In some configurations, the model learns whether a sub-task is complete by periodically attempting subsequent sub-tasks. If a subsequent sub-task can be performed, positive reinforcement is provided for the termination condition. The termination condition may also be trained using synthetic scenarios designed to test when the termination condition has been met.

In some configurations, inputs to the machine learning model are states of the world used by the model to perform a sub-task. The machine learning model produces outputs that classify an input, control an apparatus, or perform any other task that machine learning is useful for. In addition, the model outputs a termination signal reflecting a learned termination condition. The termination signal indicates whether the skill has accomplished the sub-task or not.

Inputs are from a state space, which defines the possible inputs to the model. For example, when controlling a robotic arm to move an object, inputs include the location of the arm, where the object is located, joint angles, finger force sensor data, etc. Model outputs may include joint angles, e.g. knuckle angles, and hand position. Inputs are used to infer output states as many as sixty time a second—or more—including the termination signal. When the termination signal indicates that a sub-task is complete, a check condition may be applied. In the example of grasping and picking a cup, the check condition is whether the cup can be picked up successfully. If the check condition is satisfied, then a positive reward is provided to the model, reinforcing that the termination signal was accurate. If the check condition fails, for example if the cup is not picked up successfully, then negative reinforcement is provided for the termination signal. When the termination signal was not accurate, the grasp skill may continue to adjust the knuckles and fingers until it is able to grasp properly. In some configurations, the check condition tests multiple possible subsequent sub-tasks and synthetic actions. This accounts for a greater range of possible forces and directions that the robotic arm may take when performing different subsequent sub-tasks, making the skill reusable. For example, a grasp sub-task that has been trained with a variety of check conditions may be used to move a cup to a new location, pick up a cup of water, throw the cup in the trash, etc.

When training a skill to perform a grasp sub-task, traditionally there have been two conventional rewards: proximity of the robotic arm to the object and force applied to the object caused by gripping the object. In some configurations, for the proximity-based reward, the closer the arm is to an object, the higher the reward. This helps guide the arm towards the object. The “force applied” reward is based on input from a force fingertip sensor. If the sensor reads a force, then a higher reward is given. Otherwise, a lower reward is given. In addition to these conventional rewards, a third reward is given based on whether the sub-task is complete. When training the model, once the model output says that the task is accomplished, check conditions are applied to verify that the sub-task is actually complete. If the check condition is successful, a positive completion reward is given. If the check condition is not successful, a lower or negative completion reward is given.

Training the model with a variety of possible subsequent sub-tasks ensures that the sub-task termination signal applies generally. This avoids a scenario where a sub-task termination signal is trained for a limited range of possible subsequent tasks, such that the sub-task may be complete for some subsequent sub-tasks but not others. For example, if the grasp skill is only trained with a subsequent sub-task of wiping the grasped object along the floor, the test may determine whether the object withstands the force of the grasp but not whether the object may be picked up into the air.

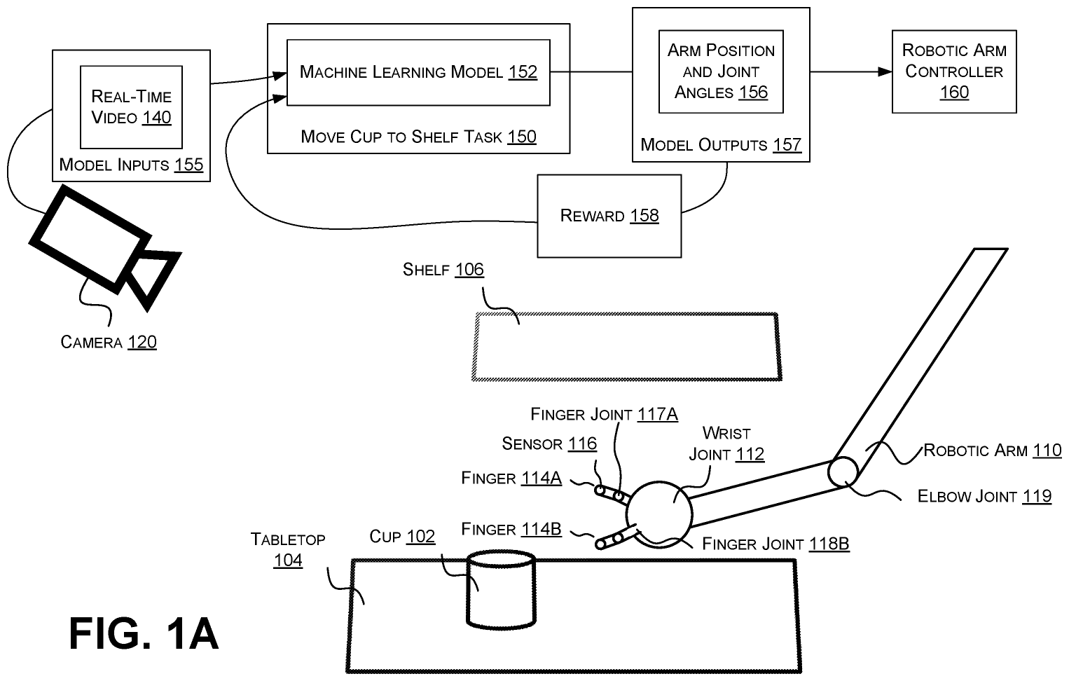

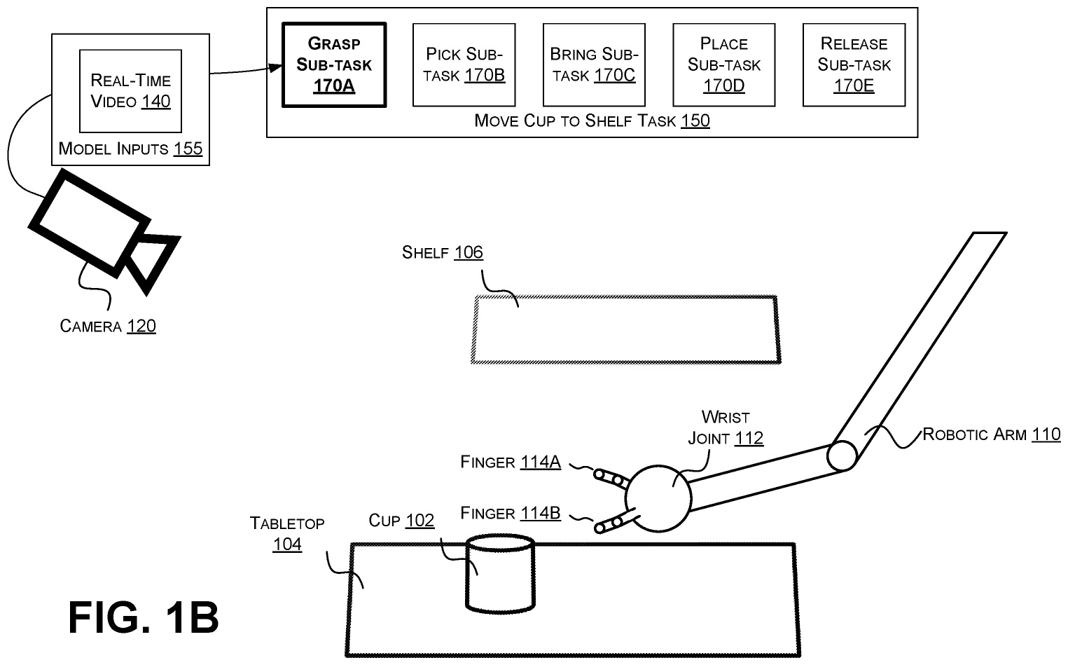

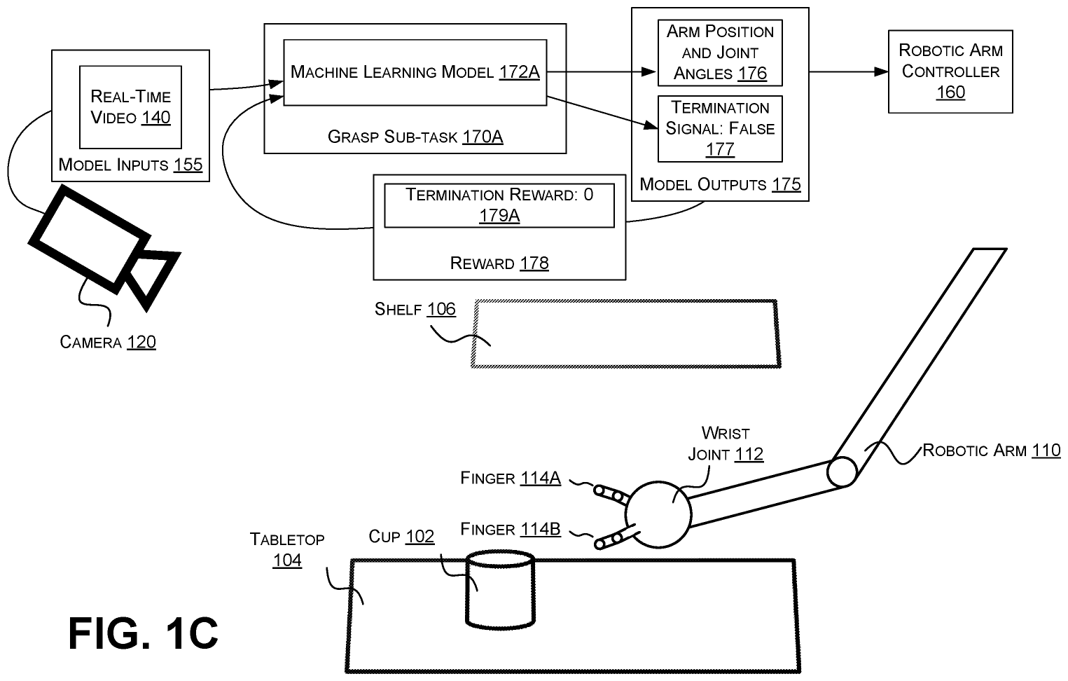

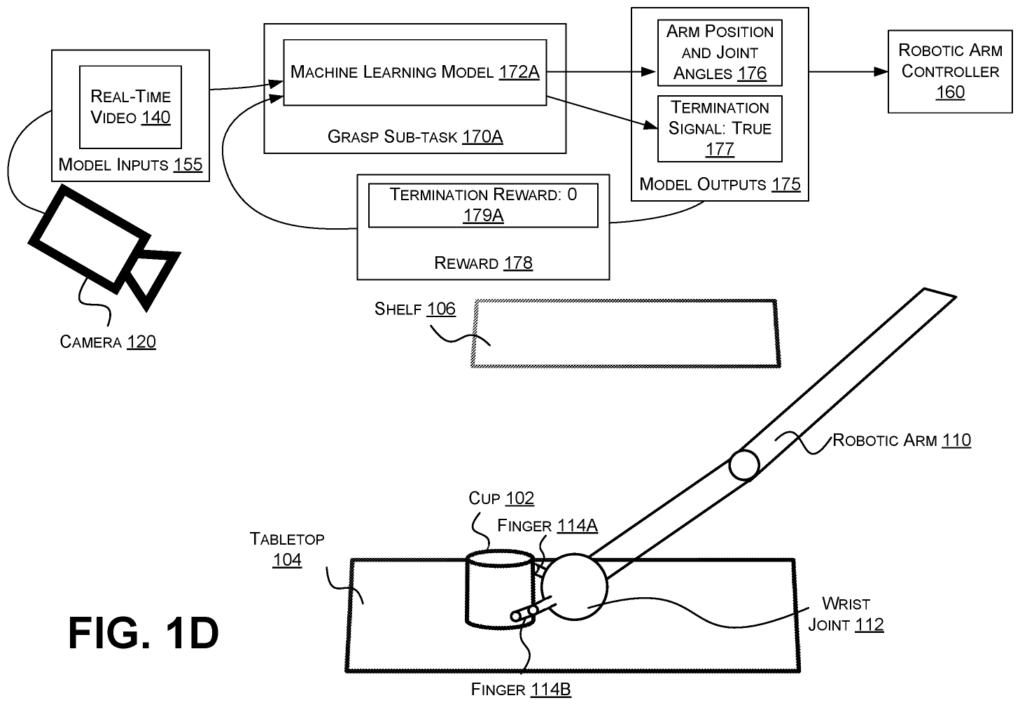

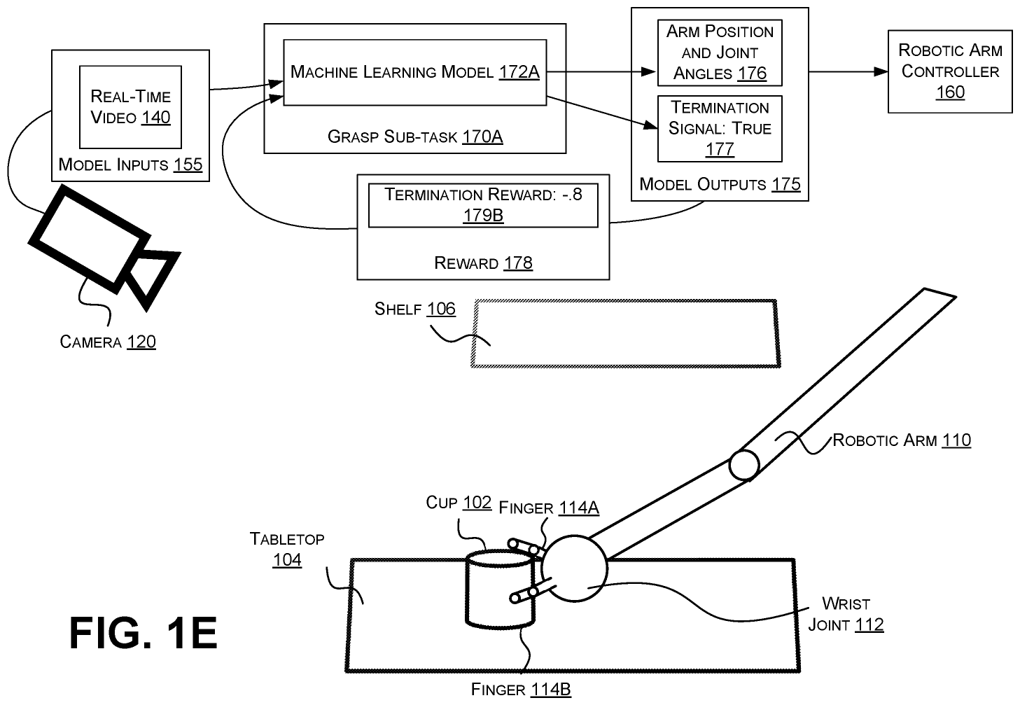

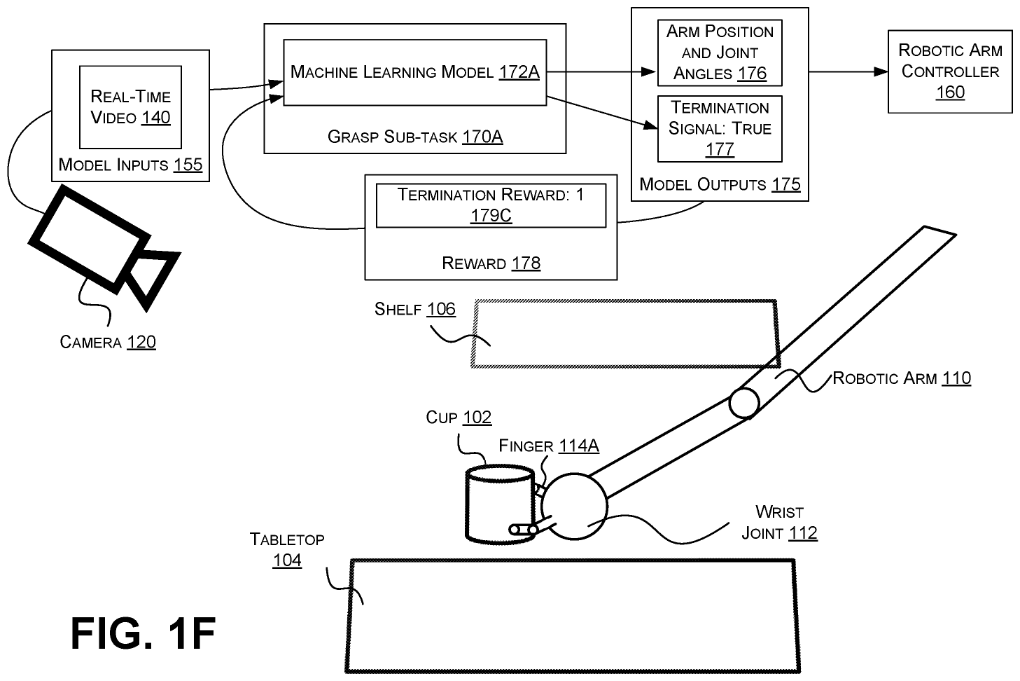

FIG. 1A illustrates an example of training a long horizon task 150 to be performed by a robotic computing device such as robotic arm 110. Cup 102 rests on tabletop 104. Task 150 is to use robotic arm 110 to move cup 102 to shelf 106. Robotic arm 110 may be moved by adjusting the angles of joints such as elbow joint 119. Robotic arm 110 may also be moved by other means, including cables, linear actuators, or the like. Robotic arm 110 has wrist joint 112, to which fingers 114A and 114B are attached. Each finger has finger joints 117 and 118, and one or more of fingers 114 is equipped with force sensor 116. While a robotic arm is used throughout this disclosure as one example of a computing device that may perform long horizon tasks, other computing devices are similarly contemplated, such as manufacturing plants, autonomous vehicles, and the like.

Machine learning model 152 may be trained with model inputs 155 to produce model outputs 157. While any type of inputs and outputs are contemplated, FIG. 1A illustrates camera 120 providing a real time video 140 as input to machine learning model 152. Camera 120 is positioned to capture the scene of robotic arm 110, table top 104, and shelf 106. Model outputs 157 include arm position and joint angles 156, which may be used by robotic arm controller 160 to control robotic arm 110.

Machine learning model 152 may be trained using reinforcement learning. Specifically, after robotic arm controller 160 applies arm position and joint angles 156 to robotic arm 110, task 150 may evaluate weather robotic arm 110 made progress towards the goal of moving cup 102 to shelf 106. Task 150 may make this determination based on video 140 and/or sensor 116. If progress was made for a given model input, reward 158 would be positive, and a backpropagation technique may be applied with the positive reward 158 to encourage model 152 towards the goal. If robotic arm 110 did not make progress towards the goal, then reward 158 would be negative, and back propagation would discourage the result for the given model input.

However, as discussed above, a long horizon task such as moving cup 102 to shelf 106 is difficult if not impossible to train in this manner. Even if training is performed with data generated with a simulator, enabling thousands or millions of attempts at achieving the goal, reward 158 is based on whether cup 102 has been placed on shelf 106, which It's not specific enough to teach robotic arm 110 to grasp cup 102.

FIG. 1B illustrates breaking the long horizon task 150 into sub-tasks 170. As illustrated, the first sub task 170A is highlighted-a sub task for grasping the cup 102. Each sub task may have a defined goal. When composed together one after another, the sub-tasks 170 perform the overall task 150 of moving the cup 102 to the shelf 106. However, task 150 is broken into subtasks 170 in such a way that reinforcement learning is practical to perform each sub-task 170. As illustrated, grasp sub-task 170A is followed by pick sub-task 170B, which is followed by bring sub-task 170C, which is followed by place sub-task 170D, which is followed by release sub task 170E.

FIG. 1C illustrates beginning to train a termination condition of a grasp sub-task 170A. Machine learning model 172A of grasp sub-task 170A generates model outputs 175, including arm position and joint angles 176 and termination signal 177. Arm position and joint angles 176 are similar to arm position and joint angles 156 in that they may be used by robotic arm controller 160 to control robotic arm 110.

However, machine learning model 172A also outputs termination signal 177. Termination signal 177 is set to true when machine learning model 172A indicates that grasp sub-task 170A is complete. Once sub-task 170A is complete, subsequent sub-task 170B may begin. Termination signal 177 is set to false when machine learning model 172A indicates that grasp sub-task 170A has not yet completed.

Reward 178 is used to train machine learning model 172A based on model inputs 155. Reward 178 includes termination reward 179A, which in some configurations is a value between −1 and 1. Any reward above 0 indicates positive reinforcement, while a reward below 0 indicates a punishment. When applied via back propagation, positive reinforcement will confirm the association between the most recent model input 155 and the termination signal 177. Similarly, when termination reward 179A is a punishment, model 172A will learn that model inputs 155 are not associated with a completed sub-task. In some configurations, when termination signal 177 is false, a termination reward 179A of 0 is provided, as there is no new information to determine if the sub-task actually has completed.

FIG. 1D illustrates moving the robotic arm 110 to touch a target object 102, triggering a termination signal 177 to be true. In response to termination signal 177 being true, a check condition is applied to determine whether grasp sub-task 170A is complete. A check condition may attempt to run a subsequent sub-task, such as sub-task 170B. In order to ensure that termination signal 177 is robust, other check conditions may be applied, such as attempting other subsequent sub-tasks which may be used by other tasks. Check conditions may also test synthetic actions that may or may not be derived from or otherwise related to a subsequent sub-task, or which may be contrived specifically to test whether grasp sub-task 170A is complete. Until a check condition is determined, termination reward 179A remains at 0.

FIG. 1E illustrates training the termination condition of the graph sub-task 170A by attempting and failing to perform a pick sub-task 170B. As illustrated, robotic arm 110 has raised itself up, but failed to properly grasp cup 102. As such, a determination is made that the subsequent “pick” sub-task 170B did not succeed, and so termination reward 179B is set to a negative number.

FIG. 1F illustrates training the termination condition of the graph sub-task 170A by attempting and succeeding to perform a pick sub-task 170B. As illustrated, robotic arm 110 has successfully picked up cup 102. This indicates that grasp sub task 170A is complete, and so termination reward 179C is set to a positive number. As such, machine learning model 172A will be trained to confirm the conditions that lead to termination signal 177 being true.

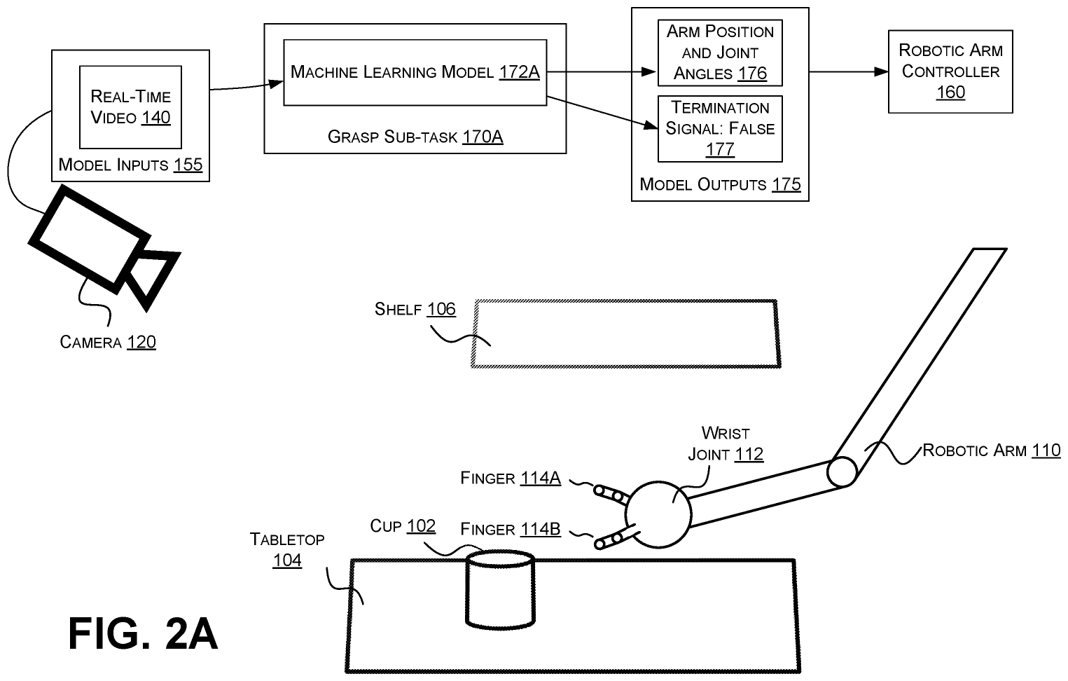

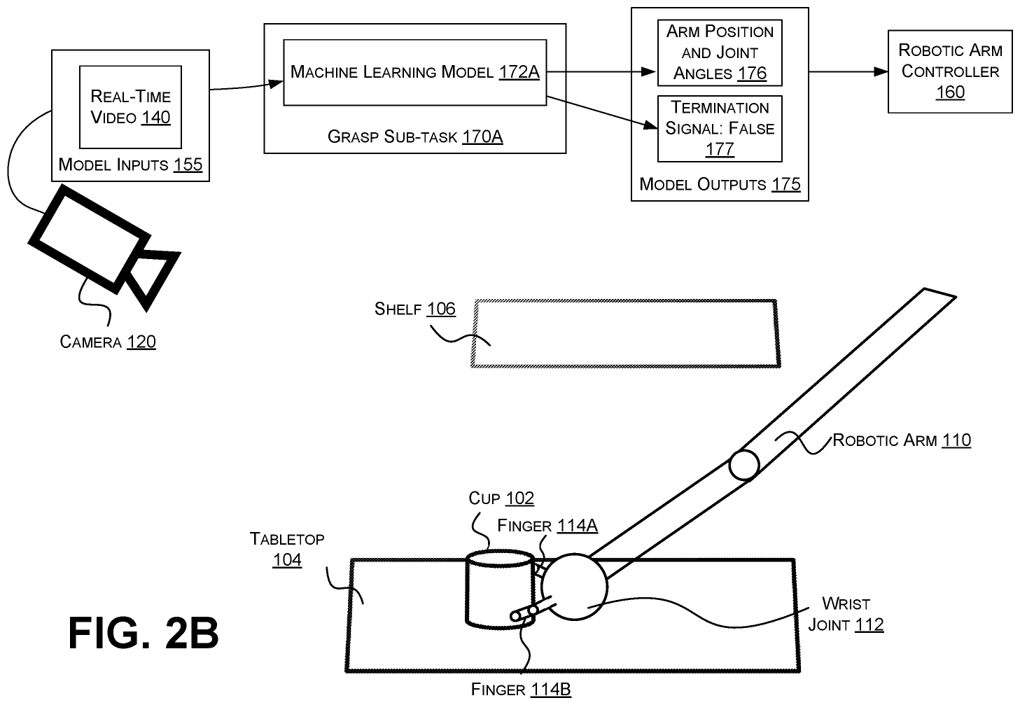

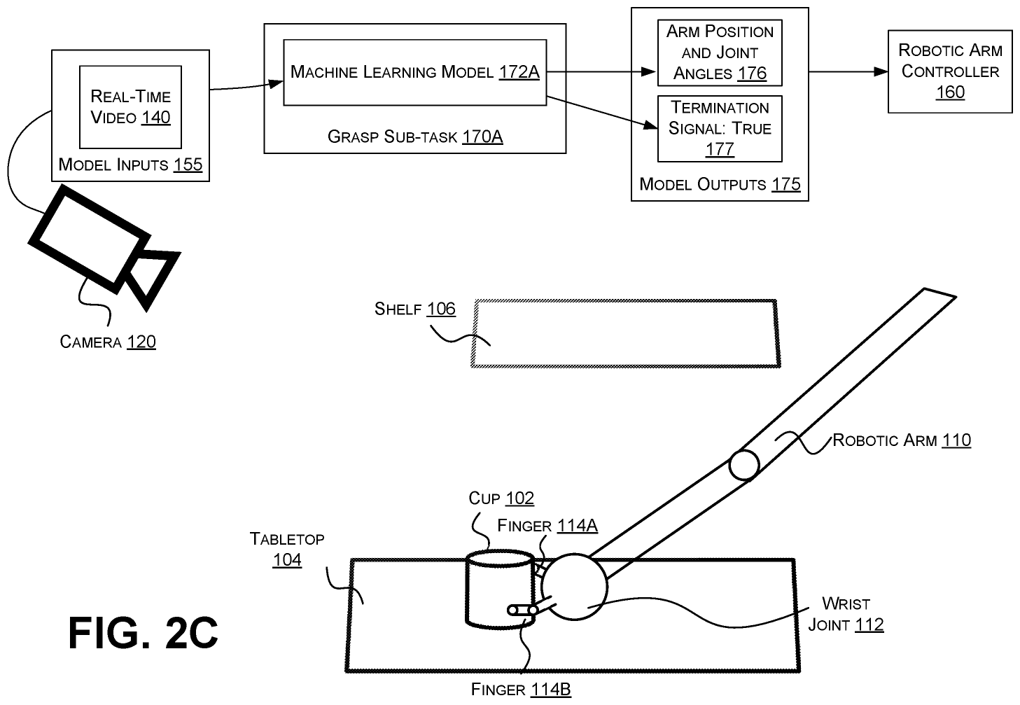

FIGS. 2A-2C illustrate applying a trained machine learning model to perform a grasp sub-task, using a termination signal to determine when the sub-task is complete. Once grasp sub-task 170A has been trained, whether with simulator data or with data generated in the real world, sub-task 170A may be used by robotic arm controller 160 to perform a grasp skill. Termination signal 177 may be consulted to determine if the grasp skill is completed and the skill that performs the subsequent sub-task 170B can begin.

In FIG. 2A, robotic arm 110 is positioned away from cup 102. Termination signal 177 is set to false accordingly, as none of the criteria used to train the completion of sub-task 170A have been met. In FIG. 2B, robotic arm 110 as moved such that fingers 114 are in contact with cup 102. However, termination signal 177 is still false, indicating that model 172A has learned that merely touching cup 102 is not enough to consider the grasp sub-task 170A complete. Finally, after adjusting finger joints 117 and 118 according to arm position and joint angles 176, termination signal 177 is inferred to be true. Accordingly, grasp sub-task 170A will end so that pick sub-task 170B may begin.

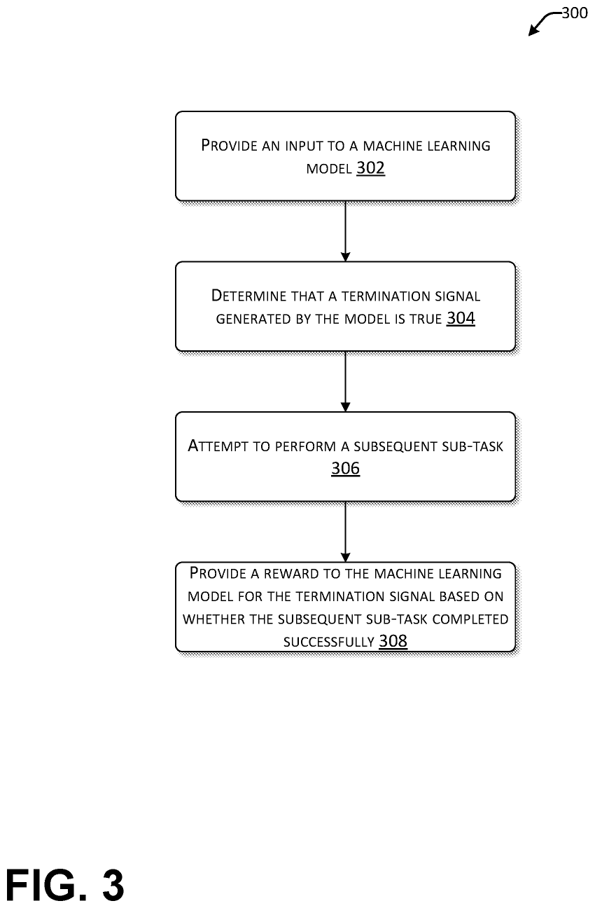

Turning now to FIG. 3, aspects of a routine for skill composition and skill training is shown and described. For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

With reference to FIG. 3, routine 300 begins at operation 302 where input 155 is provided to a machine learning model 170A.

Next at operation 304, a determination is made that a termination signal 177 generated by the model 170A is true.

Next at operation 306, an attempt is made at performing a subsequent sub-task 170B.

Next at operation 308, a reward 179A is provided to the machine learning model 172A for the termination signal 177 based on whether the subsequent sub-task 170B completed successfully.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 300 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 300 may be also implemented in many other ways. For example, the routine 300 may be implemented, at least in part, by a processor of another remote computer or a local circuit. In addition, one or more of the operations of the routine 300 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

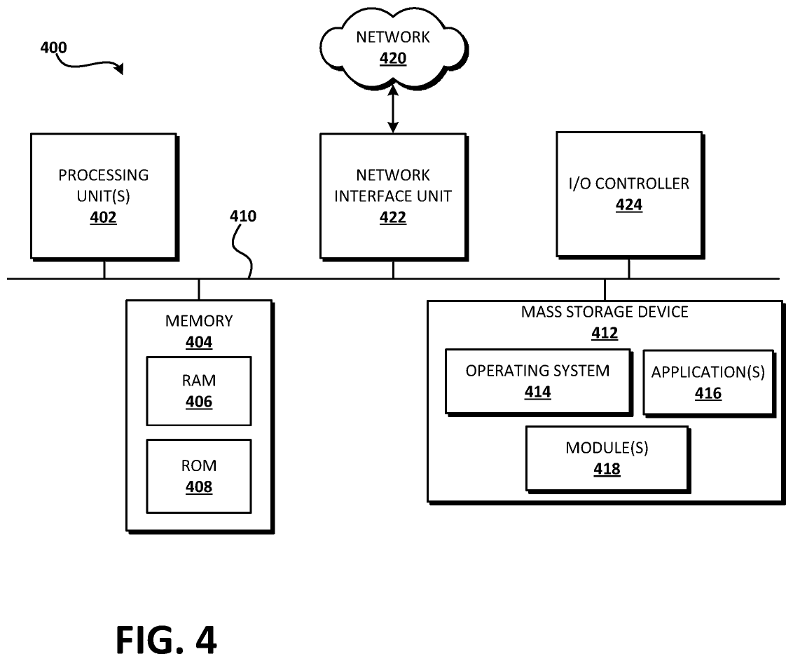

FIG. 4 shows additional details of an example computer architecture 400 for a device, such as a computer or a server configured as part of the systems described herein, capable of executing computer instructions (e.g., a module or a program component described herein). The computer architecture 400 illustrated in FIG. 4 includes processing unit(s) 402, a system memory 404, including a random-access memory 406 (“RAM”) and a read-only memory (“ROM”) 408, and a system bus 410 that couples the memory 404 to the processing unit(s) 402.

Processing unit(s), such as processing unit(s) 402, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 400, such as during startup, is stored in the ROM 408. The computer architecture 400 further includes a mass storage device 412 for storing an operating system 414, application(s) 416, modules 418, and other data described herein.

The mass storage device 412 is connected to processing unit(s) 402 through a mass storage controller connected to the bus 410. The mass storage device 412 and its associated computer-readable media provide non-volatile storage for the computer architecture 400. Although the description of computer-readable media contained herein refers to a mass storage device, it should be appreciated by those skilled in the art that computer-readable media can be any available computer-readable storage media or communication media that can be accessed by the computer architecture 400.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 400 may operate in a networked environment using logical connections to remote computers through the network 420. The computer architecture 400 may connect to the network 420 through a network interface unit 422 connected to the bus 410. The computer architecture 400 also may include an input/output controller 424 for receiving and processing input from a number of other devices, including a keyboard, mouse, touch, or electronic stylus or pen. Similarly, the input/output controller 424 may provide output to a display screen, a printer, or other type of output device.

It should be appreciated that the software components described herein may, when loaded into the processing unit(s) 402 and executed, transform the processing unit(s) 402 and the overall computer architecture 400 from a general-purpose computing system into a special-purpose computing system customized to facilitate the functionality presented herein. The processing unit(s) 402 may be constructed from any number of transistors or other discrete circuit elements, which may individually or collectively assume any number of states. More specifically, the processing unit(s) 402 may operate as a finite-state machine, in response to executable instructions contained within the software modules disclosed herein. These computer-executable instructions may transform the processing unit(s) 402 by specifying how the processing unit(s) 402 transition between states, thereby transforming the transistors or other discrete hardware elements constituting the processing unit(s) 402.

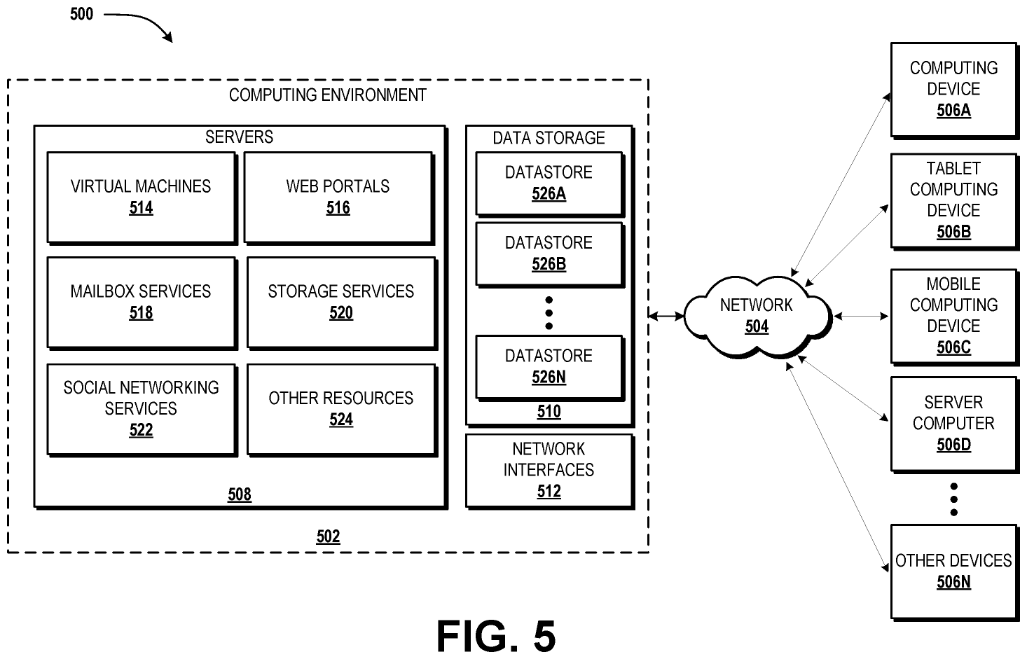

FIG. 5 depicts an illustrative distributed computing environment 500 capable of executing the software components described herein. Thus, the distributed computing environment 500 illustrated in FIG. 5 can be utilized to execute any aspects of the software components presented herein. For example, the distributed computing environment 500 can be utilized to execute aspects of the software components described herein.

Accordingly, the distributed computing environment 500 can include a computing environment 502 operating on, in communication with, or as part of the network 504. The network 504 can include various access networks. One or more client devices 506A-506N (hereinafter referred to collectively and/or generically as “clients 506” and also referred to herein as computing devices 506) can communicate with the computing environment 502 via the network 504. In one illustrated configuration, the clients 506 include a computing device 506A such as a laptop computer, a desktop computer, or other computing device; a slate or tablet computing device (“tablet computing device”) 506B; a mobile computing device 506C such as a mobile telephone, a smart phone, or other mobile computing device; a server computer 506D; and/or other devices 506N. It should be understood that any number of clients 506 can communicate with the computing environment 502.

In various examples, the computing environment 502 includes servers 508, data storage 510, and one or more network interfaces 512. The servers 508 can host various services, virtual machines, portals, and/or other resources. In the illustrated configuration, the servers 508 host virtual machines 514, Web portals 516, mailbox services 518, storage services 520, and/or, social networking services 522. As shown in FIG. 5 the servers 508 also can host other services, applications, portals, and/or other resources (“other resources”) 524.

As mentioned above, the computing environment 502 can include the data storage 510. According to various implementations, the functionality of the data storage 510 is provided by one or more databases operating on, or in communication with, the network 504. The functionality of the data storage 510 also can be provided by one or more servers configured to host data for the computing environment 502. The data storage 510 can include, host, or provide one or more real or virtual datastores 526A-526N (hereinafter referred to collectively and/or generically as “datastores 526”). The datastores 526 are configured to host data used or created by the servers 508 and/or other data. That is, the datastores 526 also can host or store web page documents, word documents, presentation documents, data structures, algorithms for execution by a recommendation engine, and/or other data utilized by any application program. Aspects of the datastores 526 may be associated with a service for storing files.

The computing environment 502 can communicate with, or be accessed by, the network interfaces 512. The network interfaces 512 can include various types of network hardware and software for supporting communications between two or more computing devices including, but not limited to, the computing devices and the servers. It should be appreciated that the network interfaces 512 also may be utilized to connect to other types of networks and/or computer systems.

It should be understood that the distributed computing environment 500 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 500 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 500 to utilize the functionality described herein for providing the techniques disclosed herein, among other aspects.

The present disclosure is supplemented by the following example clauses.

Example 1: A method for training a machine learning model to perform a sub-task of a long horizon task, the method comprising: providing an input to the machine learning model; determining that a termination signal generated by the machine learning model for the input is true; attempting to perform a subsequent sub-task; determining a termination signal reward based on whether the subsequent sub-task was successfully performed; and training the termination signal of the machine leaning model with the termination signal reward.

Example 2: The method of Example 1, wherein the sub-task and the subsequent sub-task are performed sequentially by an autonomous system performing the long-horizon task.

Example 3: The method of Example 1, wherein the trained machine learning model controls a robotic device performing the sub-task and wherein the termination signal of the machine learning model indicates that the sub-task is complete.

Example 4: The method of Example 1, wherein the subtask comprises a grasp sub-task, wherein the subsequent subtask comprises a lift sub-task, and wherein the termination signal indicates that the grasp sub-task is complete and the lift sub-task may begin.

Example 5: The method of Example 1, wherein attempting to perform the subsequent sub-task while training the machine learning model comprises performing an operation similar to but different than the subsequent sub-task.

Example 6: The method of Example 5, wherein the sub-task comprises a grasp sub-task that grasps an object laying on a surface, and wherein the operation similar to the subsequent sub-task comprises dragging the object along the surface.

Example 7: The method of Example 1, wherein attempting to perform the subsequent sub-task while training the machine learning model comprises performing the subsequent sub-task multiple times with different criteria.

Example 8: The method of Example 7, wherein the different criteria comprise different speeds, angles, locations of a robotic arm controlled by the machine learning model.

Example 9: A computer-readable storage medium having computer-executable instructions stored thereupon that, when executed by a processor, cause the processor to: provide an input to a machine learning model that controls a robotic device to perform the sub-task of the long horizon task; determine that a termination signal generated by the machine learning model for the input is true; attempt to perform a subsequent sub-task; determine a termination signal reward based on whether the subsequent sub-task was successfully performed; and train the termination signal of the machine leaning model with the termination signal reward.

Example 10: The computer-readable storage medium of Example 9, wherein the sub-task and the subsequent sub-task are simulated in a simulator.

Example 11: The computer-readable storage medium of Example 10, wherein the sub-task comprises grasping an object with a robotic arm, wherein the subsequent sub-task comprises lifting the object, and wherein the subsequent sub-task is determined to not be successfully performed when the object slips from the robotic arm while the subsequent sub-task is performed.

Example 12: The computer-readable storage medium of Example 11, wherein negative reinforcement is provided to the termination condition of the machine learning model in response to determining that the subsequent sub-task is not successfully performed.

Example 13: The computer-readable storage medium of Example 10, wherein the sub-task comprises grasping an object with a robotic arm, wherein the subsequent sub-task comprises lifting the object, and wherein the subsequent sub-task is determined to be successfully performed when the robotic arm continues to grasp the object throughout the subsequent sub-task.

Example 14: The computer-readable storage medium of Example 10, wherein the termination signal of the machine learning model is trained multiple times with different simulated coefficients of friction or different simulated degrees of deformity of an object grasped by a robotic arm.

Example 15: A computing device, comprising: a processor; and a computer-readable storage medium storing computer-executable instructions that, when executed by the processor, cause the computing device to: provide an input to a machine learning model that controls a robotic device to perform the sub-task of the long horizon task; determine that a termination signal generated by the machine learning model for the input is true; attempt to perform a subsequent sub-task; determine a termination signal reward based on whether the subsequent sub-task was successfully performed; and train the termination signal of the machine leaning model with the termination signal reward.

Example 16: The computing device of Example 15, wherein the sub-task comprises creating a mold as part of a manufacturing process and the subsequent sub-task comprises installing a part in the mold.

Example 17: The computing device of Example 15, wherein the input to the machine learning model comprises a video stream, an audio signal, force sensor data, or position sensor data.

Example 18: The computing device of Example 15, wherein an output of the machine learning model comprises a joint angle usable to control a robotic computing device.

Example 19: The computing device of Example 15, wherein the termination signal reward provides positive reinforcement to the termination signal of the machine learning model when the subsequent sub-task completes successfully.

Example 20: The computing device of Example 15, wherein an input to the machine learning model includes a state of a robotic computing device controlled by the machine learning model, a state of an object being manipulated by the robotic computing device, force sensor data, or a state of an environment surrounding the robotic computing device and the object, and wherein an output of the machine learning model includes a joint angle or a hand position of the robotic computing device.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for training a machine learning model to perform a sub-task of a long horizon task, the method comprising:
providing an input to the machine learning model;
determining that a termination signal generated by the machine learning model for the input is true;
attempting to perform a subsequent sub-task;
determining a termination signal reward based on whether the subsequent sub-task was successfully performed; and
training the termination signal of the machine leaning model with the termination signal reward.

2. The method of claim 1, wherein the sub-task and the subsequent sub-task are performed sequentially by an autonomous system performing the long-horizon task.

3. The method of claim 1, wherein the trained machine learning model controls a robotic device performing the sub-task and wherein the termination signal of the machine learning model indicates that the sub-task is complete.

4. The method of claim 1, wherein the subtask comprises a grasp sub-task, wherein the subsequent subtask comprises a lift sub-task, and wherein the termination signal indicates that the grasp sub-task is complete and the lift sub-task may begin.

5. The method of claim 1, wherein attempting to perform the subsequent sub-task while training the machine learning model comprises performing an operation similar to but different than the subsequent sub-task.

6. The method of claim 5, wherein the sub-task comprises a grasp sub-task that grasps an object laying on a surface, and wherein the operation similar to the subsequent sub-task comprises dragging the object along the surface.

7. The method of claim 1, wherein attempting to perform the subsequent sub-task while training the machine learning model comprises performing the subsequent sub-task multiple times with different criteria.

8. The method of claim 7, wherein the different criteria comprise different speeds, angles, locations of a robotic arm controlled by the machine learning model.

9. A computer-readable storage medium having computer-executable instructions stored thereupon that, when executed by a processor, cause the processor to:
provide an input to a machine learning model that controls a robotic device to perform the sub-task of the long horizon task;
determine that a termination signal generated by the machine learning model for the input is true;
attempt to perform a subsequent sub-task;
determine a termination signal reward based on whether the subsequent sub-task was successfully performed; and
train the termination signal of the machine leaning model with the termination signal reward.

10. The computer-readable storage medium of claim 9, wherein the sub-task and the subsequent sub-task are simulated in a simulator.

11. The computer-readable storage medium of claim 10, wherein the sub-task comprises grasping an object with a robotic arm, wherein the subsequent sub-task comprises lifting the object, and wherein the subsequent sub-task is determined to not be successfully performed when the object slips from the robotic arm while the subsequent sub-task is performed.

12. The computer-readable storage medium of claim 11, wherein negative reinforcement is provided to the termination condition of the machine learning model in response to determining that the subsequent sub-task is not successfully performed.

13. The computer-readable storage medium of claim 10, wherein the sub-task comprises grasping an object with a robotic arm, wherein the subsequent sub-task comprises lifting the object, and wherein the subsequent sub-task is determined to be successfully performed when the robotic arm continues to grasp the object throughout the subsequent sub-task.

14. The computer-readable storage medium of claim 10, wherein the termination signal of the machine learning model is trained multiple times with different simulated coefficients of friction or different simulated degrees of deformity of an object grasped by a robotic arm.

15. A computing device, comprising:
a processor; and
a computer-readable storage medium storing computer-executable instructions that, when executed by the processor, cause the computing device to:
provide an input to a machine learning model that controls a robotic device to perform the sub-task of the long horizon task;
determine that a termination signal generated by the machine learning model for the input is true;
attempt to perform a subsequent sub-task;
determine a termination signal reward based on whether the subsequent sub-task was successfully performed; and
train the termination signal of the machine leaning model with the termination signal reward.

16. The computing device of claim 15, wherein the sub-task comprises creating a mold as part of a manufacturing process and the subsequent sub-task comprises installing a part in the mold.

17. The computing device of claim 15, wherein the input to the machine learning model comprises a video stream, an audio signal, force sensor data, or position sensor data.

18. The computing device of claim 15, wherein an output of the machine learning model comprises a joint angle usable to control a robotic computing device.

19. The computing device of claim 15, wherein the termination signal reward provides positive reinforcement to the termination signal of the machine learning model when the subsequent sub-task completes successfully.

20. The computing device of claim 15, wherein an input to the machine learning model includes a state of a robotic computing device controlled by the machine learning model, a state of an object being manipulated by the robotic computing device, force sensor data, or a state of an environment surrounding the robotic computing device and the object, and wherein an output of the machine learning model includes a joint angle or a hand position of the robotic computing device.
